(19) United States
(12) Patent Application Publication
(10) Pub. No.: US 2009/0205559 A1
(43) Pub. Date: Aug. 20, 2009

(54) POINTER FOR USE IN A GAUGE, A GAUGE EMPLOYING THE POINTER, AND A METHOD OF MAKING THE POINTER

(75) Inventors: Raymond A. Lia, Auburn, NY (US); Uwe Valentin, Hechingen (DE)

Correspondence Address: Hiscock & Barclay, LLP, One Park Place, 300 South State Street, Syracuse, NY, 13202-2078, US

(73) Assignee: Welch Allyn, Inc., Skaneateles Falls, NY (US)

(21) Appl. No.: 12/034,286

(22) Filed: Feb. 20, 2008

(51) Int. Cl. G01L 19/12

(52) U.S. Cl. 116/271

(57) ABSTRACT

A gauge for measuring the magnitude of a measurable quantity, such as fluid pressure. The gauge includes a rotatable axle or shaft intended to rotate in response to different magnitudes of the quantity being measured and includes a dial possessing indicia corresponding to different magnitudes of such quantity. The improvement in the gauge relates to a very light-weight pointer having a needle section and a counterbalance section, in which the needle section is formed of a relatively light mass material, preferably balsa wood. The counterbalance section may be fashioned of a different, denser material. The surface of the counterbalance section may be provided with a series of parallel depressions that aid in cutting or trimming the counterbalance section to achieve a balance of the pointer about the axle or shaft. A method of making such a pointer is also disclosed.

### FIELD OF THE INVENTION

This invention generally relates to gauges, especially those having dial indicators for indicating the magnitude of a measurable quantity, such as the magnitude of a fluid pressure, and especially to pointers used for such gauges. The invention also relates to a method of making such a pointer.

### BACKGROUND OF THE INVENTION

Gauges, such as those for measuring the magnitude of a measurable quantity, such as the magnitude of a fluid pressure, including sphygmomanometers used for measuring blood pressure, often employ an arcuate dial bearing indicia about the perimeter thereof to designate various magnitudes or levels of the fluid pressure or other quantity being measured by the gauge. Such gauges also often employ a rotatable axle or shaft on which a pointer is mounted to rotate concurrently with the shaft. Various mechanisms are employed to rotate the shaft in correlation with changes in the magnitude of the fluid pressure or other quantity being measured, which causes a concurrent rotation of the pointer. By observing the location of the pointer relative to the dial indicia, an observer may determine the magnitude of the fluid pressure or other quantity being measured.

A common problem with the pointers of such gauges is that they bounce during movement, thereby making it difficult for an observer to obtain an accurate determination of the true rotatable position of the pointer that correlates with the magnitude of the quantity being measured. Such bouncing is caused by the moment of inertia of the pointer, based upon the Newtonian principle that a body in motion tends to stay in motion. Thus, when the pointer rotates, it will “overshoot”, then bounce in a reverse direction and “undershoot”, etc.

The problem of bounce is more pronounced with the size of the gauge dial and with the concomitant length and mass of the associated pointer. As the pointer length and mass increase, the moment of inertia also increases, resulting in more extreme bouncing. Also, the phenomenon of bounce is most acute when the magnitude of the quantity being measured changes suddenly, extremely, or frequently. One way of lessening the bounce is to provide a relatively compact counterweight or counterbalance such that the pointer has a needle portion, the position of which is to be read in connection with the dial indicia, with the counterbalance portion located on the side of the axle or shaft opposite to the needle portion. Another way of lessening the bounce of the pointer is to fashion the pointer, especially the needle section, so that it possesses a relatively small mass. However, attempts to fashion the needle section of a material having a relatively small mass have been frustrated because the materials from which needle sections have been fashioned typically possess a relatively low strength, and the configuration of the needle cannot be advantageously modified to provide increased strength (for example, in an “I” beam configuration). When the needle section has a relatively low stiffness or strength, then the needle section tends to fatigue and warp, sometimes to the degree of causing the needle section to scrape against the dial, causing the needle section to bend, or otherwise to function in a way that does not permit quick, accurate readings of the magnitude of the fluid pressure or other quantity being measured.

### SUMMARY OF INVENTION

The present invention relates to a gauge for measuring the magnitude of a measurable quantity, such as fluid pressure. The gauge includes a rotatable axle or shaft intended to rotate in response to different magnitudes of the quantity being measured and includes a dial possessing indicia corresponding to different magnitudes of such quantity. The improvement in the gauge relates to a very light-weight pointer having a needle section and a counterbalance section in which the needle section is formed of a relatively light mass material, preferably balsa wood. The counterbalance section may be fashioned of a different, denser material. The surface of the counterbalance section may be provided with a series of parallel depressions that aid in cutting or trimming the counterbalance section to achieve a balance of the pointer about the axle or shaft. A method of making such a pointer is also disclosed.

### BRIEF DESCRIPTION OF THE DRAWINGS

The invention will be described with reference to the accompanying drawings, wherein:

FIG. 1 is a sectional view of a prior art pressure measuring device or gauge having a prior art pointer element for purposes of illustrating an exemplary environment of the present invention;

FIG. 2A is a top view of a needle section of a pointer in accordance with a first embodiment of the present invention;

FIG. 2B is a side view of the needle section shown in FIG. 2A;

FIGS. 3A-3D are exemplary cross sectional views of the needle section of the pointer shown in FIG. 2A taken along the line 3-3;

FIG. 4 is a top view of a metal plate that may be disposed over the base end of the needle section shown in FIGS. 2A and 2B;

FIG. 5 is an exploded perspective illustration of the plate shown in FIG. 4 disposed over the base end of the needle section shown in FIGS. 2A and 2B adapted for mounting engagement with an axle hub;

FIG. 6 is a top view of a needle section of a pointer in accordance with a second embodiment of the present invention;

FIG. 7A is a top perspective view of a base section of the pointer adapted to accommodate the needle section shown in FIG. 6;

FIG. 7B is a bottom perspective view of the base section shown in FIG. 7A displaying an integrally molded axle hub thereon;

FIG. 8 is a top view of a pointer employing the needle section substantially as shown in FIG. 6 and the base section substantially as shown in FIGS. 7A and 7B mounted on a rotatable axle or shaft and positioned over a dial of a gauge;

FIG. 9A is a top perspective view of another base section of a pointer in accordance with a third embodiment of the present invention;

FIG. 9B is a bottom perspective view of the base section shown in FIG. 9A displaying an integrally molded axle hub thereon; and

FIG. 9C is a bottom plan view of the base section shown in FIGS. 9A and 9B.

### DESCRIPTION OF A PREFERRED EMBODIMENT

The present invention will be described with reference to the accompanying drawings, wherein like reference numerals refer to the same item. It should be evident to those skilled in the relevant technological art that other variations and modifications can be made utilizing the inventive concepts described herein as well as utilizing alternate applications beyond those specifically described.

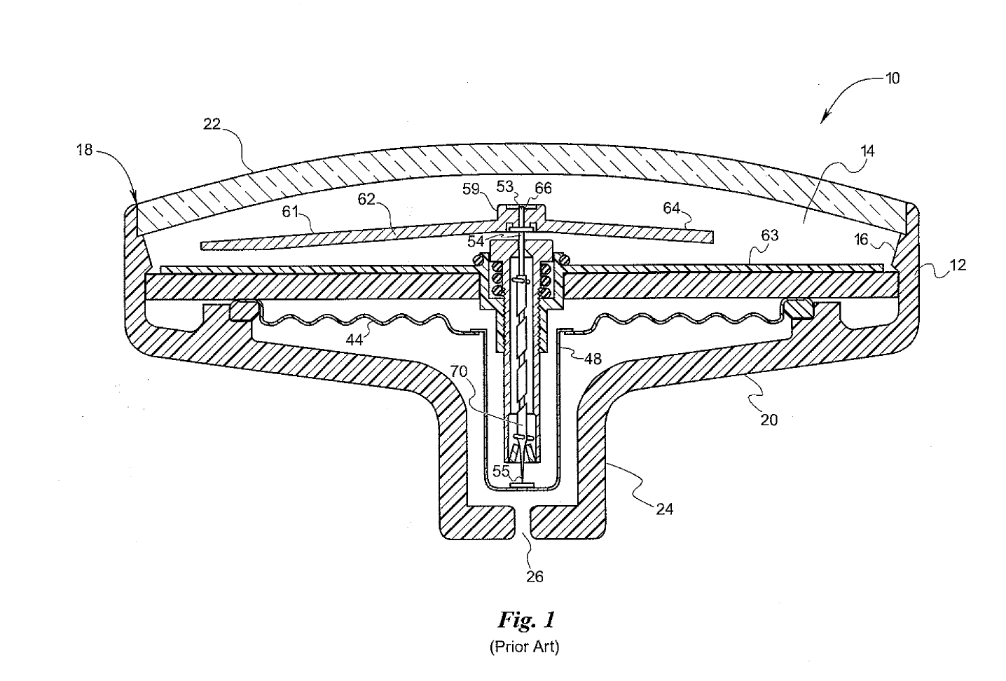

The present invention is preferably utilized with a gauge for measuring the magnitude of a measurable quantity, including those relating to the pressure of a fluid, such as barometers, pressure sensitive switches, and sphygmomanometers. One such prior art gauge is disclosed in FIG. 1, which relates to a pressure measuring device 10 including a substantially cylindrical housing 12 having an anterior cavity 14 defined by a circumferential inner wall 16, an open top end 18, and a bottom end 20. A window or bubble 22, made from crystal, glass, plastic, or any convenient transparent material, is attached in a known manner to the open top end 18 of the housing 12. Although the window or bubble 22 is shown as a slightly curved or convex shape, it should be appreciated that other configurations, such as a flat configuration, may be utilized advantageously. The bottom end 20 of the housing 12 possesses a diameter which inwardly tapers to a narrow, downwardly extending portion 24 having a bottom opening 26 that serves as a port for admitting a fluid, such as air.

The pressure measuring device 10 further includes a dial face 63 having indicia (not shown) distributed circmferentially therearound. The pressure measuring device 10 also includes a pointer element 62 that is mounted to the protruding top end 53 of a shaft 54. The pointer element 62 is made from a light-weight plastic material and includes a center hub 59 having a through-aperture 66 for receiving the shaft's protruding top end 53, as well as a bottom-sided recess (not shown) which accommodates a locking member (not shown) of the shaft 54. The pointer element 62 includes an indicating portion 61 and a counterbalancing portion 64, each oppositely and axially disposed relative to the center hub 59.

Briefly, in operation, a change in the pressure of an incoming fluid, such as air, enters the bottom opening 26 of the housing 12 and into the interior cavity of the housing 12. An increase in pressure concurrently causes a flexible diaphragm 44 to move upwardly a pan 48 which in turn pushes upwardly against the bottom end 55 of the axially displaceable shaft 54. Such action, in turn, causes a ribbon spring 70 to act against and cause the shaft 54 to rotate, which in turn causes a corresponding circumferential movement of the pointer element 62 attached to top end 53 of the shaft 54 relative to the indicia (not shown) provided on the dial face 63.

The prior art shown in FIG. 1 is disclosed in more detail in U.S. Pat. No. 6,644,123, of which the current inventors are co-inventors.

In accordance with the present invention, a gauge employs an extremely light-weight, but stiff and strong, pointer preferably fashioned of wood, even more preferably balsa wood. Such balsa wood is obtained from a large, fast-growing tree, also known as ochroma pyramidale, which is native to tropical South America, Central America, and southern Mexico. It is also envisioned that some species of wood, such as some varieties of cedar, spruce, yellow pine, Douglas fir, and bamboo, might be advantageously employed instead of balsa. The density of dry balsa wood ranges from approximately four to twenty-four pounds per cubic foot, with commercial grades typically ranging from about six to eighteen pounds per cubic foot. For purposes of the present invention, differences in the technical meanings of the terms “mass” and “weight” are not significant, though technically “mass” is an inertial property measured by the tendency of an object to remain at constant velocity unless acted upon by an outside force, whereas the “weight” of an object is entirely dependent upon the strength of the local gravity field acting upon that object (in contrast to the mass of the same object, which is independent of gravitational effects). Since the earth's gravitational field is essentially constant on the earth's surface, where the present invention is most likely to be employed, an object having a constant mass will essentially also have a constant weight for purposes of describing the invention. Mass is typically expressed in metric units such as kilograms, whereas weight is typically expressed in units such as pounds. The density of balsa or other wood may be expressed in metric units by recognizing that 100 kilograms per cubic meter equals approximately 6.6 pounds per cubic foot. Thus, the density range of balsa wood may also be expressed in metric units of about 50 to 500 kilograms per cubic meter, with commercial grades having a density of about 90 to 270 kilograms per cubic meter.

The density of balsa wood, and any other wood, is affected by the moisture content of the wood. When wood is first harvested, when it is so-called “green”, the wood typically has a moisture content over 25 percent and even up to 50 percent, and when aged and dried, settles at a reduced moisture content of approximately 12 percent (the moisture content is the weight of the water compared to the weight of the wood). Even when a wood is considered “dry”, the moisture content might fall to 7-8 percent in dry climates, and rise to 18-20 percent in humid climates. Generally, the density of wood changes by about 0.5 percent for each percentage point variation from 12 percent moisture content, so, for example, a wooden board at 18 percent moisture content will be about 3 percent heavier than the same wooden board when at 12 percent moisture content.

For its relatively low density, balsa wood has a relatively high stiffness and strength. To further compound considerations regarding the density of balsa wood and its strength, commercial balsa wood is typically fashioned by cutting a log in different planes relative to the growth rings of the log. A so-called “A-grain” or “tangent” cut produces a sheet of balsa wood that will be fairly flexible from edge to edge; a so-called “C-grain” or “quarter” cut will produce a balsa wood sheet that will be relatively rigid from edge to edge, and will be difficult to bend; and a so-called “B-grain” or “random” cut will have intermediate properties between the A-grain and the C-grain cuts.

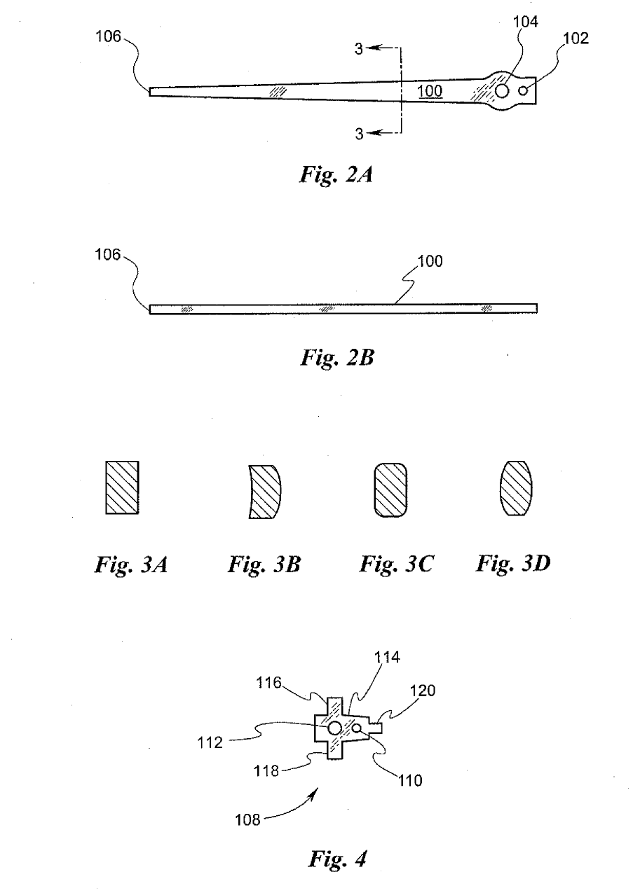

There is shown in FIGS. 2A and 2B a needle section 100 of a pointer in accordance with one embodiment of the present invention. Preferably, the needle section 100 is fashioned of a light-weight wood, such as balsa wood. The base end of the needle section 100 is provided with a first, relatively small through-aperture 102 and a second, relatively large through-aperture 104. As shown in FIG. 2A, the needle section 100 tapers gradually along its lateral peripheral edges from the base end thereof to a point or tip 106. A side profile of the needle section 100, as shown in FIG. 2B, indicates that preferably the needle section 100 possesses an essentially uniform thickness, which is still relatively thin, on the order of 0.015 inches or in the range of about twelve to twenty one-thousandths of an inch in thickness.

In cross-section taken perpendicular to the length of the needle section 100, the needle section 100 preferably possesses a rectangular configuration, however, the corners may be rounded, the surfaces may be convex, concave, or otherwise curved, irregularly shaped, or configured. Exemplary configurations are shown in FIGS. 3A-3D. Also preferably at least the top facing surface of the needle section is painted, such as by spraying paint onto the needle section 100 or by dipping the needle section 100 into a pool of paint. Such painting obscures the visual difficulties of viewing an untreated needle section 100, which may present grain pattern and other wood color variations. Also, by choosing a vivid color, especially a color with high contrast with the color of any associated dial face, an observer may more easily and readily determine the position of the needle section 100 relative to indicia on the dial. Such painting also helps to seal the surface of the needle section 100, which improves the stability of the moisture content and the longevity of the needle section 100.

In addition to reducing the effects of bounce of the pointer by reducing the mass of the needle section, the effects of bounce can also be reduced by shortening the counterbalance section of the pointer, that is, the portion of the pointer that is generally axially opposite to the needle section. For the pointer embodiment shown in FIGS. 2A and 2B, a thin metal plate 108, as shown in FIG. 4, is provided for mounting over and on the base end of the needle section 100. Although the plate 108 has been described as a metal plate and may be fashioned, for example, from aluminum, it should be appreciated that the plate 108 may be fashioned of other relatively heavy materials, including a plastic, a carbon composite, an epoxy, or even a much denser wood. The plate 108 preferably includes a central body portion 114 having a peripheral contour that generally corresponds with the peripheral contour of the base end of the needle section 100. The plate 108 also preferably includes a pair of through-apertures 110 and 112, which are sized, spaced, and otherwise positioned so as to correspondingly align with the apertures 102, 104, respectively, in the base end of the needle section 100. The plate 108 further preferably includes a pair of bendable ears 116, 118 that extend laterally from opposite sides of the central body portion 1 14, and a bendable tail or end tab 120.

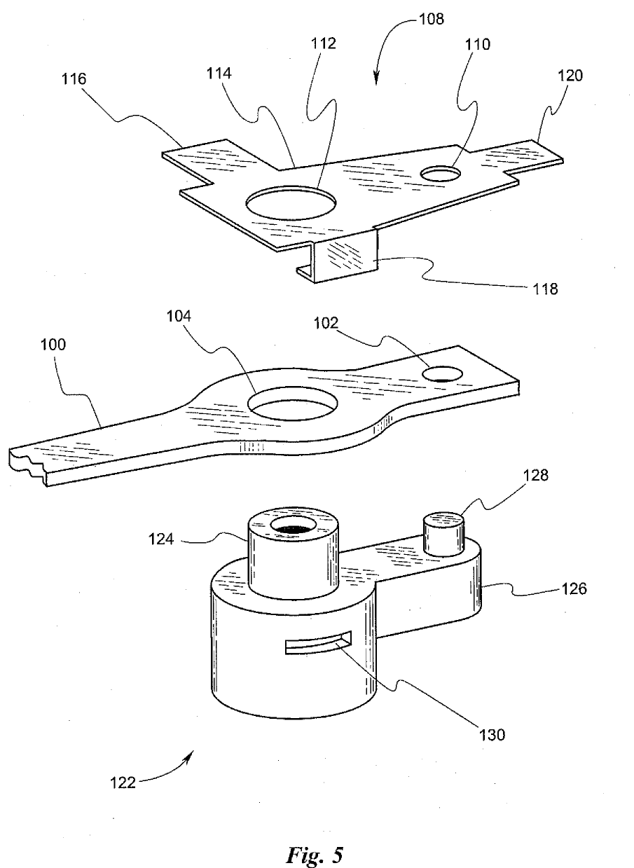

As best shown in FIG. 5, the plate 108 is disposed intimately over and mounted on the based end of the needle section 100 such that the apertures 102 and 110 are aligned with the apertures 104 and 112. The plate 108 and the needle section 100 are together adapted to be mounted to an axle hub 122, which is an extension of the rotatable axle or shaft of a gauge. The axle hub 122 possesses a generally cylindrical configuration and along one longitudinal end thereof possesses a boss 124 possessing a circular periphery that corresponds with the circular peripheries of the apertures 104 and 112. The hub 122 also includes a radially extending arm 126 upon which is mounted a nipple 128 that also possesses a circular periphery corresponding with the circular periphery of the apertures 102 and 110. The hub 122 also possesses a pair of diametrically opposed slots 130 in its periphery, only one of which is shown in FIG. 4.

As will be appreciated from viewing FIG. 5, the needle section 100 is mounted over and to the hub 122 such that the boss 124 extends through the aperture 104 and the nipple 128 extends through the aperture 102. Thereafter, the plate 108 is positioned over the base of the needle section 100 and the hub 122 such that the boss 124 extends through the aperture 112 and the nipple 128 extends through the aperture 110. Next, the plate 108 is secured to the hub 122 by bending each of the lateral ears 116 and 118 into the corresponding one of the two slots 130 in the hub 122 and by bending the tail tab 120 around the distal end of the arm 126. In such a construction, the base end of the needle section 100 will be compressively sandwiched between the plate I 08 and the hub 122. It should be appreciated that the plate 108 may be further secured to the base end of the needle section 100, and the needle section 100 may be further secured to the hub 122 by additionally using a glue or other adhesive, or that instead of crimping the plate 108 to the hub 122 via the lateral ears 116, 118 and the tail tab 120, only glue or adhesive may be utilized to secure the components together. When so assembled, both the needle section 100 and the plate 108 will rotate concurrently with the axle hub 122 which is an extension of the rotatable axle or shaft of the gauge.

It will be appreciated that when the base end of the needle section 100 and the metal plate 108 are mounted together on the hub 122, the pointer comprising the needle section 100 and the plate 108 possesses a longitudinal axis and possesses bilateral symmetry about that longitudinal axis. Also, very preferably, the pointer possesses both longitudinal and lateral balance about the center of the boss 124.

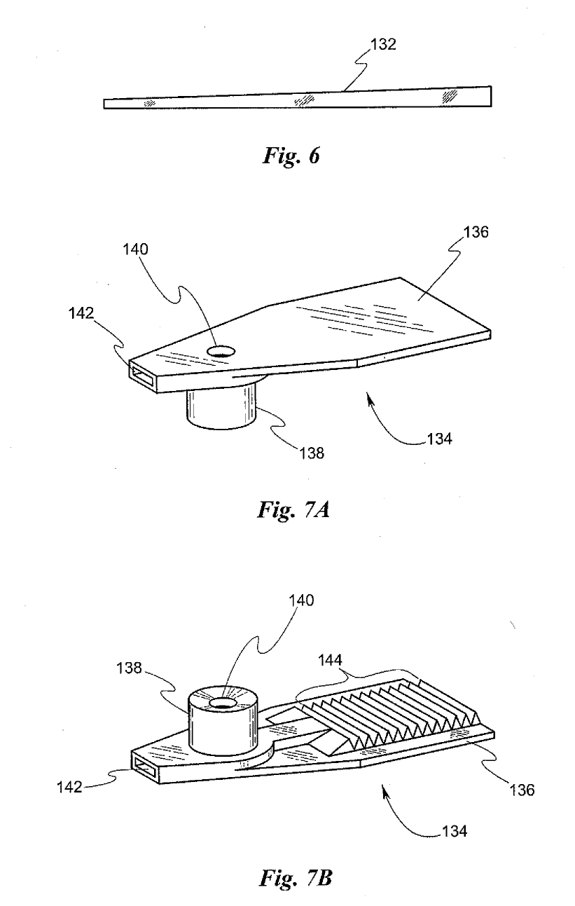

There is shown in FIGS. 6, 7A and 7B a pointer in accordance with yet another embodiment of the present invention. The needle section 132 uses a blunt base end, with the lateral peripheral edges of the needle section 132 gradually tapering from the base end to a tip or point. The needle section 132 may be fashioned of the same sorts of material, such as light-weight wood, and very preferably balsa wood, as the needle section 100 shown in FIGS. 2A and 2B. The needle section 132 may also possess the same uniform, relatively thin thickness.

The pointer including the needle section 132 also includes a base segment 134 as shown in FIGS. 7A and 7B. The base segment 134 is preferably fashioned of an integrally molded, unitary piece of material, such as a plastic, but which may be a metal, an epoxy, a relatively heavy wood, or other suitable material. The base segment 134 generally possesses a relatively thin plate section 136 having a generally “V” or “U” shaped peripheral configuration and includes a generally cylindrically shaped hub 138 having a longitudinal axis that is generally perpendicular to the plane of the plate 136. A through-aperture 140 extends through the base segment 134 generally along the longitudinal axis of the hub 138. The rotatable axle or shaft of the gauge is adapted to extend through the aperture 140 and may be secured to the base segment 134 by compression fit or with an adhesive, for example.

One relatively narrow end of the plate 136 possesses a slot or cavity 142 configured to snugly receive the blunt end of the needle section 132 such that the needle section 132 and the base segment 134 are permanently joined together. The blunt end of the needle section 132 may be press fit into the cavity 142, and alternatively, or in addition, the two components may be secured together with a glue or adhesive, through ultrasonic or spot welding, or by heat staking the region of the plate 136 in the vicinity of the cavity 142. It will be appreciated that when the needle section 132 is joined to the base segment 134, the overall pointer will possess a longitudinal axis and will possess bilateral symmetry about that axis. Again, it is very preferable that the pointer be balanced both longitudinally and laterally about the center of the aperture 140.

As shown in FIG. 7B, the underside surface of the plate 136 is preferably provided with a series of parallel, equally spaced, linear ridges 144 with corresponding linear depressions therebetween. The ridges 144 may be utilized in connection with attaining a preferred longitudinal balance of the pointer, especially where needle sections 132 of different tapers, of different lengths, and otherwise of different characteristics, may be employed with the base segment 134. Before mounting the pointer on the rotatable axle or shaft of a gauge, it is preferable that the balance of the pointer be tested. In one method, the pointer is mounted over a pin centered in the aperture 140 such that the pointer is allowed to tip about the pin. If it is observed that the pointer tips with the counterbalance section relatively downward, then some of the mass or weight of the counterbalance section may be reduced by trimming the plate 136. Such trimming may be accomplished by using a razor blade, a pair of scissors, or other cutting utensil to sever the plate 136 along a depression between adjacent ones of the ridges 144. Since the ridges 144 are preferably arranged orthogonal to the longitudinal axis of the pointer, the bilateral symmetry of the pointer will be maintained, and the lateral balance of the pointer will also preferably be preserved. When the plate 136 is so trimmed, the pointer may be re-mounted on the pin for further testing of the balance, and if necessary, the plate 136 may be trimmed in a similar manner until the pointer does not tip and is evenly balanced.

It should be appreciated that although the series of ridges 144 are shown to have a regular profile and are evenly spaced, the shapes of the ridges may differ, and the spacing between the ridges may differ. Also, although the ridges 144 shown in FIG. 7B are linear, it is possible that the ridges may have a “V” configuration or, an arcuate configuration, or some other configuration. The ridges 144 may be formed in the bottom surface or in the top surface of the plate 136; the ridges may extend only partially or completely across the lateral extent of the counterbalance section 136; and the depressions between the ridges 144 may extend to various, selected depths through the thickness of the plate 136. It is also envisioned that the depressions between the ridges may be serrated or scored with spaced holes so that the plate 136 may be more easily trimmed with a cutting utensil, or may even be trimmed by snapping the plate 136 along a selected score line.

Balsa wood is relatively inexpensive, is readily, commercially available, is easy to fabricate, is extremely light-weight, and is relatively stiff or strong. An advantage of wood, such as balsa wood, is that the wood is generally not static sensitive. In many gauges, static electricity can build up, especially in the bubble or window above the pointer and the dial face, and may adversely affect the proper operation of a pointer fashioned of a metal or other material that is sensitive to static electricity. In some instances, a human finger passing over the window of a gauge deviates the pointer simply because of the effects of the static electricity. These effects can even occur when a pointer is coated with a metallic paint. Such effects are more dramatic with a lighter weight pointer. The present invention contemplates that the pointer may be sprayed with an anti-static coating composition, or alternatively or additionally, the components of the pointer may be impregnated during the manufacturing process with an anti-static additive composition.

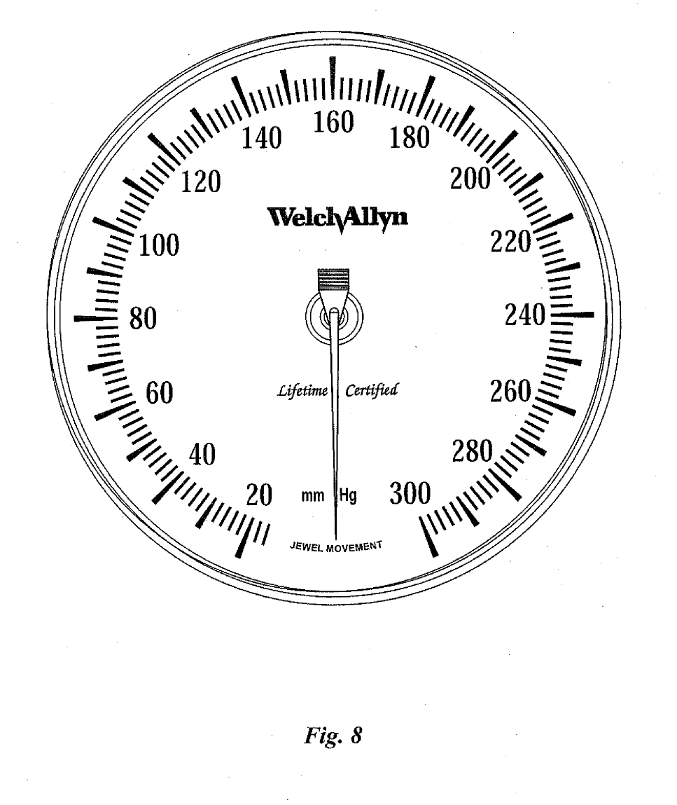

There is shown in FIG. 8, a pointer very similar to the pointer shown in FIGS. 6, 7A and 7B mounted on a rotatable axle or shaft above a dial on which is printed indicia in the form of radially extending dashes and associated numerals in a circumferential arrangement centered about the axle. In the particular dial shown in FIG. 8, the indicia relate to blood pressure levels in reference to a sphygmomanometer manufactured by Welch Allyn. It will be appreciated that the pointer shown in FIG. 8 includes a needle section 146 very similar to those shown in FIGS. 6, 7A and 7B, however, instead of a slot or cavity 142, the base segment 148 is provided with a “U” shaped slot for receiving the blunt end of the needle section 146 and that the series of ridges 144 and associated depressions are disposed on the top surface of the base segment 148.

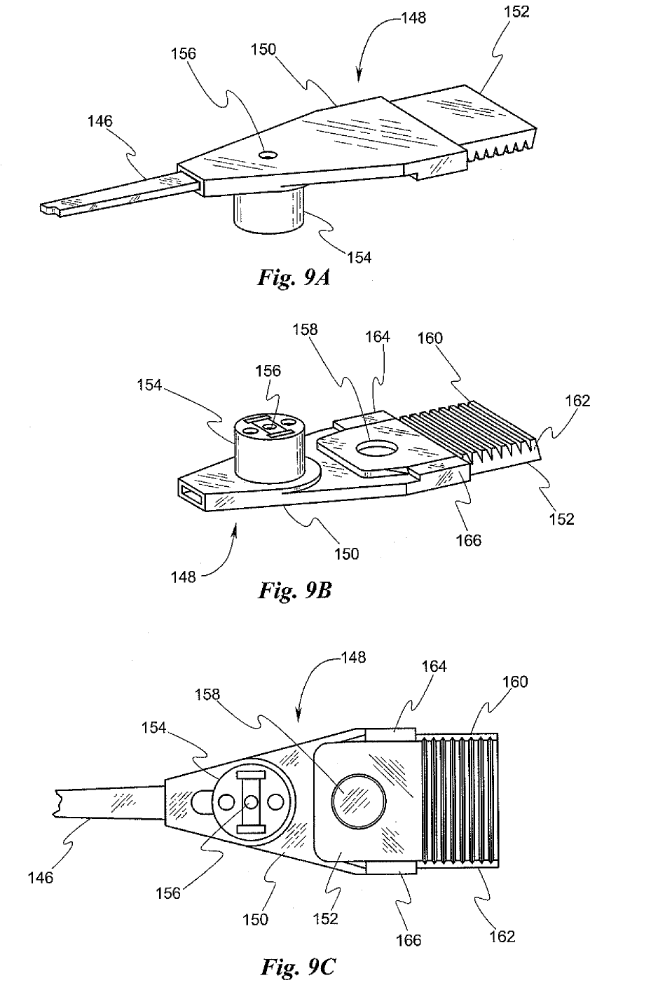

There is shown in FIGS. 9A 9C another embodiment of the pointer according to the present invention. The pointer includes a needle section 146 that may be generally constructed in accordance with the variations previously described herein. The pointer also includes a base segment 148 that is preferably fashioned in two pieces, each of which is preferably integrally molded of a unitary material, such as plastic, but which may be metal or other suitable material. The base segment 148 generally includes a main body piece 150 along with a tail piece 152. The main body piece 150 generally possesses a relatively thin plate section have a generally “V” or “U” shaped peripheral configuration and includes a generally cylindrically shaped hub 154 having a longitudinal axis that is generally perpendicular to the plane of the thin plate section. A through-aperture 156 extends through the main body piece 150 generally along the longitudinal axis of the hub 154. The rotatable axis or shaft of the gauge is adapted to extend through the aperture 156 and may be secured to the main body piece 150 by compression fit or with an adhesive, for example.

The needle section 146 may be secured to the base segment 148 and particularly the main body piece 150 in a manner similar to that previously described with reference to FIGS. 6, 7A, and 7B.

Whereas in FIGS. 7A and 7B the base segment 134 possesses a series of parallel ridges and associated depressions preferably integrally molded into the (single-piece) base segment 134, the embodiment shown in FIGS. 9A-9C includes a tail piece 152 that may be selectively, slidably, and matingly received by the main body piece 150. The tail piece 152 preferably includes a circular aperture that is configurated to conformingly receive a short, cylindrical boss 158 depending perpendicularly down from the thin plate section of the main body piece 150. Preferably, the aperture in the tail piece 152 is adapted to be “press fit” or “snap-fit” onto the boss 158, or maybe glued or otherwise secured to either the boss 158 or the remaining portion of the main body piece 150, as desired. The tail piece 152 preferably possesses beveled, parallel, lateral edges 160, 162 that are adapted to be slidably and conformingly received with correspondingly shaped parallel, internal faces of a pair of clasping arms 164, 166 in the main body piece 150, as best shown in FIGS. 9B and 9C. In construction, as best appreciated by viewing FIGS. 9A-9C, the forward end of the tail piece 152 is initially inserted between the clasping arms 164 and 166 and then urged forwardly until the aperture of the tail piece 152 overlaps and receives the boss 158 thereby at least temporarily securing the tail piece 152 to the main body piece 150.

The tail piece 152 preferably possesses a series of parallel, equally spaced ridges and associated depressions similar to those shown in FIG. 7B. It should appreciated that the present invention also contemplates that the ridges and depressions may be modified in the same manner as previously discussed with reference to FIG. 7B. Also, with regard to the embodiment shown in FIGS. 9A-9C, the tail piece 152 may be selectively inserted into and removed from the main body piece 150 whereby testing of the overall balance of the pointer may be conducted with the tail piece 152 inserted completely into the main body piece 150, and then, if necessary, the tail piece 152 may be removed in order to be trimmed, and then reinserted into a matingly engaged relationship with the main body piece 150. Alternatively, the tail piece 152 may be permanently secured to the main body piece 150 such as by gluing.

It should also be appreciated with regard to the embodiment in FIGS. 9A 9C, because of the removeability of the tail piece 152, tail pieces 152 of different lengths, or otherwise of different weights may be utilized with the main body piece 150. In this inventive variation, the tail piece 152 may or may not be provided with any ridges or depressions or other structures that assist in trimming the tail piece 152.

It is believed that the foregoing invention is especially useful for relatively large dial blood pressure gauges provided with relatively large dials (for example, up to or more than 100 millimeters in diameter), that utilize a so-called Durashock movement. However, it should be appreciated that the invention has much broader applicability than such particular gauges, such dials, and such pointer lengths.

It will be readily apparent to those who are skilled in the art that other variations and modifications to the foregoing described preferred embodiments are possible within the spirit and scope of the invention as defined by the following claims.

We claim:

1. A gauge for measuring the magnitude of a measurable quantity, said gauge including a rotatable axle adapted to rotate in response to different magnitudes of the quantity and a dial possessing indicia corresponding to different magnitudes of the quantity, the improvement comprising:
an elongate pointer adapted for substantially concurrent and radially coextensive rotation with said axle, said pointer comprising:
a needle section and a counterbalance section, wherein said needle section consists primarily of a first unitary material possessing a density of less than about 500 kilograms per cubic meter.

2. A gauge according to claim 1 wherein said needle section consists primarily of a first unitary material possessing a density substantially in the range of about 60 to 300 kilograms per cubic meter.

3. A gauge according to claim 1 wherein said first unitary material comprises wood.

4. A gauge according to claim 2 wherein said first unitary material comprises balsa wood.

5. A gauge according to claim 1 wherein said counterbalance section consists primarily of a second unitary material different from said first unitary material.

6. A gauge according to claim 1, wherein said counterbalance section consists primarily of a second unitary material different from said first unitary material, wherein said pointer is elongated substantially along a longitudinal axis and substantially possesses bilateral symmetry along said longitudinal axis, wherein said pointer further includes a socket adapted to receive said axle, and wherein said pointer possesses a mass distribution such that said pointer is substantially evenly balanced longitudinally about said socket.

7. A gauge according to claim 6 wherein said counterbalance section includes means for assisting in the trimming of said counterbalance section.

8. A gauge according to claim 7 wherein said assisting means comprises a series of substantially parallel depressions formed in a surface of said second unitary material.

9. A gauge according to claim 6 wherein said second unitary material comprises a plastic.

10. A gauge according to claim 9 wherein said second unitary material comprises a plastic impregnated with an antistatic additive.

11. A gauge according to claim 8 wherein said second unitary material comprises a plastic.

12. A gauge according to claim 11 wherein said second unitary material comprises a plastic impregnated with an antistatic additive.

13. A gauge for measuring the magnitude of a measurable quantity, said gauge including a rotatable axle adapted to rotate in response to different magnitudes of the quantity and a dial possessing indicia corresponding to different magnitudes of the quantity, the improvement comprising:
an elongate pointer adapted for substantially concurrent and radially coextensive rotation with said axle, said pointer comprising:
a needle section and a counterbalance section, wherein said needle section consists essentially entirely of a first unitary material possessing a density of less than about 500 kilograms per cubic meter.

14. A gauge according to claim 13 wherein said needle section consists essentially entirely of a first unitary material possessing a density substantially in the range of about 60 to 300 kilograms per cubic meter.

15. A gauge according to claim 13 wherein said first unitary material comprises balsa wood.

16. A gauge according to claim 13, wherein said counterbalance section consists essentially entirely of a second unitary material different from said first unitary material, wherein said pointer is elongated substantially along a longitudinal axis and substantially possesses bilateral symmetry along said longitudinal axis, wherein said pointer includes a socket adapted to receive said axle, and wherein said pointer possesses a mass distribution such that said pointer is substantially evenly balanced longitudinally about said socket.

17. A gauge according to claim 14, wherein said counterbalance section consists essentially entirely of a second unitary material different from said first unitary material, wherein said pointer is elongated substantially along a longitudinal axis and substantially possesses bilateral symmetry along said longitudinal axis, wherein said pointer includes a socket adapted to receive said axle, and wherein said pointer possesses a mass distribution such that said pointer is substantially evenly balanced longitudinally about said socket.

18. A gauge according to claim 15, wherein said counterbalance section consists essentially entirely of a second unitary material different from said first unitary material, wherein said pointer is elongated substantially along a longitudinal axis and substantially possesses bilateral symmetry along said longitudinal axis, wherein said pointer includes a socket adapted to receive said axle, and wherein said pointer possesses a mass distribution such that said pointer is substantially evenly balanced longitudinally about said socket.

19. A gauge according to claim 13 wherein said pointer possesses a longitudinal length, a width, and a thickness and wherein said needle section possesses a thickness substantially in the range of about 10 to 25 one-thousandths of an inch substantially throughout the length of said needle section.

20. A gauge according to claim 14 wherein said pointer possesses a longitudinal length, a width, and a thickness and wherein said needle section possesses a thickness substantially in the range of about 10 to 25 one-thousandths of an inch substantially throughout the length of said needle section.

21. A gauge according to claim 15 wherein said pointer possesses a longitudinal length, a width, and a thickness and wherein said needle section possesses a thickness substantially in the range of about 10 to 25 one-thousandths of an inch substantially throughout the length of said needle section.

22. A gauge according to claim 16 wherein said pointer possesses a longitudinal length, a width, and a thickness and wherein said needle section possesses a thickness substantially in the range of about 10 to 25 one-thousandths of an inch substantially throughout the length of said needle section.

23. A gauge according to claim 17 wherein said pointer possesses a longitudinal length, a width, and a thickness and wherein said needle section possesses a thickness substantially in the range of about 10 to 25 one-thousandths of an inch substantially throughout the length of said needle section.

24. A gauge according to claim 18 wherein said pointer possesses a longitudinal length, a width, and a thickness and wherein said needle section possesses a thickness substantially in the range of about 10 to 25 one-thousandths of an inch substantially throughout the length of said needle section.

25. A pointer adapted for use in rotatable association with a dial, said pointer including:
means for assisting in trimming said pointer whereby the mass distribution of said pointer may be modified.

26. A pointer according to claim 25 wherein said assisting means comprises a series of substantially parallel depressions formed in the surface of said pointer.

27. A pointer according to claim 25 wherein said pointer includes a needle section and a base segment comprising at least two separate pieces of material, one of which comprises a body piece and another of which comprises a tail piece, wherein said body piece includes one of at least one pair of cooperating features and said tail piece includes another of said at least one pair of cooperating features, each pair of cooperating features adapted to guide and secure said body piece and said tail piece into a selected position with respect to each other, and wherein said tail section includes said assisting means.

28. A pointer according to claim 27 wherein said at least one pair of cooperating features comprise a boss and an aperture conformingly shaped with and adapted to receive said boss.

29. A pointer according to claim 27 wherein said at least one pair of cooperating features comprise at least one lateral edge and at least one clasping arm conformingly shaped with said lateral edge and adapted to receive said lateral edge.

30. A pointer adapted for use in rotatable association with a dial, said pointer including:
a needle section;
a base segment comprising at least two separate pieces of material, one of which comprises a body piece and another of which comprises a tail piece, wherein said body piece includes one of at least one pair of cooperating, mating features and said tail piece includes another of said at least one pair of cooperating, mating features, each pair of cooperating, mating features adapted to guide and secure said body piece and said tail piece into a related position with respect to each other; and
said pointer elongated substantially along a longitudinal axis and substantially possessing bilateral symmetry along said longitudinal axis, said pointer including a socket, said pointer being substantially evenly balanced longitudinally about said socket.

31. A pointer according to claim 30 wherein said at least one pair of cooperating, mating features comprise a boss and an aperture conformingly shaped with and adapted to receive said boss.

32. A pointer according to claim 30 wherein said at least one pair of cooperating, mating features comprise at least one lateral edge and at least one clasping arm conformingly shaped with said lateral edge and adapted to receive said lateral edge.

33. A fluid pressure gauge comprising:
a dial possessing indicia substantially corresponding to different fluid pressure levels;
a fluid pressure level detector;
an axle rottable in response to the fluid pressure level detected by said fluid pressure level detector; and
a pointer mounted on said axle and rotatable substantially concurrently and radially coextensively with said axle, said pointer disposed over said dial, whereby the position of said pointer relative to said dial indicia substantially indicates the fluid pressure level detected by said fluid pressure level detector;
wherein the improvement comprises said pointer comprising a needle section and a counterbalance section, wherein said needle section consists essentially entirely of a first unitary material possessing a density of less than about 500 kilograms per cubic meter.

34. A fluid pressure gauge according to claim 33 wherein said needle section consists essentially entirely of a first unitary material possessing a density substantially in the range of about 60 to 300 kilograms per cubic meter.

35. A fluid pressure gauge according to claim 34 wherein said first unitary material comprises balsa wood.

36. A fluid pressure gauge according to claim 33 wherein said pointer includes a socket adapted to receive said axle, said pointer possesses a mass distribution such that said pointer is substantially evenly balanced longitudinally about said socket.

37. A fluid pressure gauge according to claim 34 wherein said pointer includes a socket to receive said axle, said pointer possesses a mass distribution such that said pointer is substantially evenly balanced longitudinally about said socket.

38. A fluid pressure gauge according to claim 35 wherein said pointer includes a socket to receive said axle, said pointer possesses a mass distribution such that said pointer is substantially evenly balanced longitudinally about said socket.

39. A method of manufacturing a pointer adapted for use in rotatable association with a dial, comprising the steps of:
providing a pointer including means for assisting in trimming said pointer whereby the mass distribution of said pointer is modified;
trimming said pointer by utilizing said assisting means.

40. A method of manufacturing a pointer adapted for use in rotatable association with a dial, comprising the steps of:
providing a pointer elongated substantially along a longitudinal axis and substantially possessing bilateral symmetry along said longitudinal axis, said pointer including a socket, said pointer including means for assisting in trimming said pointer whereby the mass distribution of said pointer is modified;
testing the balance of said pointer longitudinally about said socket;
trimming said pointer by utilizing said assisting means; and
retesting the balance of said pointer longitudinally about said socket.

41. A method of manufacturing a pointer according to claim 40 wherein said assisting means comprises a series of substantially parallel depressions formed in the surface of said pointer and wherein said depressions extend in a direction substantially orthogonal to said longitudinal axis.
